(19) United States
(12) Patent Application Publication
(10) Pub. No.: US 2019/0287049 A1
(43) Pub. Date: Sep. 19, 2019

(54) METHODS AND SYSTEMS FOR GENERATING A DIGITAL SHIPPING PLAN

(71) Applicant: Flexport, Inc., San Francisco, CA (US)

(72) Inventors: Aaron Patrick O'BRIEN, San Francisco, CA (US); Mary BECICA, El Cerrito, CA (US)

(21) Appl. No.: 16/353,898

(22) Filed: Mar. 14, 2019

Related U.S. Application Data
(60) Provisional application No. 62/642,899, filed on Mar. 14, 2018.

(51) Int. Cl. G06Q 10/08; G06Q 30/02

(52) U.S. Cl. CPC G06Q 10/083; G06Q 30/0282

(57) ABSTRACT

In an embodiment, the methods and systems disclosed herein utilize a cloud-based shipping plan generation system to generate a shipping plan for transport a shipment commercially. In an embodiment, information in collected on a number of commercial vehicle operators, commercial vehicles and shipments and the information is used as the basis for the generation of the shipping plan. In an embodiment, a dispatcher reviews two or more shipping plans and selects one shipping plan to be carried out by a commercial vehicle operator.

### BENEFIT CLAIM

This application claims the benefit under 35 U.S.C. § 119(e) of provisional application 62/642,899 filed Mar. 14, 2018, the entire contents of which is hereby incorporated by reference for all purposes as if fully set forth herein.

### TECHNICAL FIELD

One technical field of the present disclosure is freight shipping and management. Another technical field is computer systems for data collection and optimization.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Items in commerce are any items, objects, products, work-product, or tools which are transported from one location to another as part of a commercial transaction or contract. The modern freight shipping industry involves transporting copious amounts of items and products to and from various locations around the world and often across numerous borders. As a result, modern shipping processes must track and manage large amounts of logistical information in order to efficiently and accurately transport objects from one location to another. Integral to the movement of objects are commercial vehicle operators, whom are responsible for transporting the goods in commercial vehicles.

When an object arrives at a management facility to prepare it for transport to a final destination, the facility may track the object from arrive to departure. Departure takes place when a commercial vehicle operator takes control of the object and begins transporting to object toward the final destination. The commercial vehicle operator may be from a different company and utilizes different tracking technology and standards than the management facility. Therefore the commercial vehicle operator is not part of the preparation process at the management facility and vice-versa. Dispatchers, or those who coordinate the transfer of objects to commercial vehicle operators often select the commercial vehicle operators who will transport the objects by using personal knowledge and guesswork.

A dispatcher may personally choose to employ a commercial vehicle operator having a certain set of traits which are desirable, but inefficient for the selected transportation job. For example, a dispatcher may choose a well-known commercial vehicle operator to transport an object over a long distance, but the commercial vehicle operator may have multiple jobs requiring multiple stops in other locations, increasing the transportation time and the cost of shipment. Technology employed by commercial vehicle operators provides a plethora of statistics and measurements about the commercial vehicle operator and their vehicle to shipping companies, but with such information is often unavailable to management facilities. As a result, the efficient and cost-effective generation of shipping plans is left to best-guess decision-making by human dispatchers. Therefore, there exists a need in the fields of commercial shipping to integrate tracking information available for commercial vehicle operators with management facilities systems to generate efficient and cost-effective shipping plans which will save time and money for management facility operators and commercial vehicle operators alike.

### SUMMARY

The appended claims may serve as a summary of the invention.

### BRIEF DESCRIPTION OF THE DRAWINGS

In the drawings:

FIG. 1 depicts a system that may be used to implement an embodiment.

FIG. 2 depicts an example process that may govern the operation of an embodiment.

FIG. 3 depicts an example general purpose computer system that may be used to implement aspects of an embodiment.

FIG. 4 depicts an example process that may govern the operation of an embodiment.

FIG. 5 depicts an example embodiment that may be used in implementing the example process.

FIG. 6 depicts an example embodiment that may be used in implementing the example process.

FIG. 7 depicts an example embodiment that may be used in implementing the example process.

FIG. 8 depicts an example embodiment that may be used in implementing the example process.

FIG. 9 depicts an example embodiment that may be used in implementing the example process.

FIG. 10 depicts an example embodiment that may be used in implementing the example process.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

In various embodiments of the techniques herein, a computer implemented method receives information relating to a plurality of commercial vehicle operators, commercial vehicles, and objects which will be shipped commercially (“shipments”). The information is sent from a variety of interconnected systems, such as smart devices employed by commercial vehicles operators, electronic logging devices (ELD) integrated into commercial vehicles, shipping information logged at facility servers, etc.

The information is collected at a cloud-based service which has access to all the information necessary to generate a valid shipping plan to transport the shipment with a commercial vehicle operated by a commercial vehicle operator. The cloud-based service interprets information and automatically generates the most preferable shipping plan according to time and cost constraints, in addition to any parameters specified by a management facility or commercial vehicle operator.

The preferable shipping plan is then sent to either a dispatcher to approve the plan or directly to a commercial vehicle operator for faster implementation of the preferable shipping plan. In some instances, multiple plans may be generated which can be selected from by the dispatcher or the commercial vehicle operator. Once the cloud-based service has collected information, used the information to generate a shipping plan, and the plan has been approved, the shipping plan can be carried out by the commercial vehicle operator as the plan specifies.

Generation of a preferable shipping plan automatically saves significant time and computing resources over traditional methods of manually selecting a commercial vehicle operator and commercial vehicle to transport a shipment. Manual plan generation performed by human dispatchers are subject to human error and time inconsistencies, and are subject to inefficient practices such as dispatcher bias for or against certain commercial vehicle operators or commercial vehicle operating companies, selection of incompatible vehicles in a certain shipment, valuation of time-saving plans over cost-effective plans, etc. The method described herein saves precious computer processing resources, computer memory, network bandwidth, and time, by quickly, efficiently, and accurately generating preferred computer plans. The field of commercial transportation, which constantly grows exponentially more complex, is greatly improved by such a method for reducing shipping waste in the form of time, cost, and manual plan generation.

### System Implementation

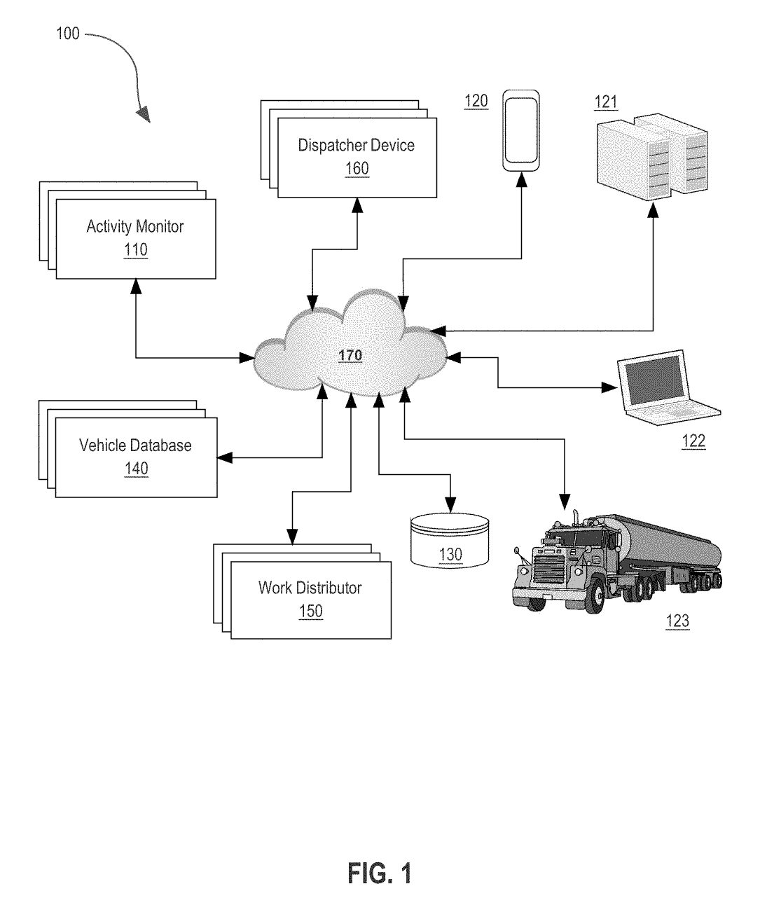

FIG. 1 depicts an example system 100 for the generation of shipping plans. Network 170 connects devices and systems 110-160. Network 170 may be any appropriate local area network, internet, and/or other type of network or communication mechanism, including those discussed herein. Network 170 may allow the facilitation of a cloud-based server which uses devices and system 110-160 to generate shipping plans. Coupled to network 170 is activity monitor 110. Activity monitor 110 may be any device, system, or entity which is capable of receiving and sending information related to a commercial vehicle operator, commercial vehicles, and/or shipments.

Vehicle Database 140 is connected to network 170. Vehicle database 140 may be any device, system, or entity capable of storing information related to commercial vehicles. In various embodiments, vehicle database stores vehicle information obtained from activity monitor 110. Work distributor 150 is connected to network 170. Work distributor may be any device, system, or entity capable of receiving information relating to commercial vehicle operators, commercial vehicles, and shipments and generating a shipping plan. In various embodiments, Work distributor 150 receives information from activity monitor 110 and/or vehicle database 140 to generate a shipping plan.

Dispatcher device 160 is connected to network 170. Dispatcher device 160 may be any device, system, or entity capable of receiving a shipping plan. In various embodiments, dispatcher device receives a shipping plan from work distributor 150. Coupled to network 170 is one or more storage devices 140 which may be used in lieu of any device, system or entity capable of storing digital information as otherwise discussed herein. Devices 120-123 are connected to network 170. Devices 120-123 may be any device, system, or entity which may further aid in generating a shipping plan.

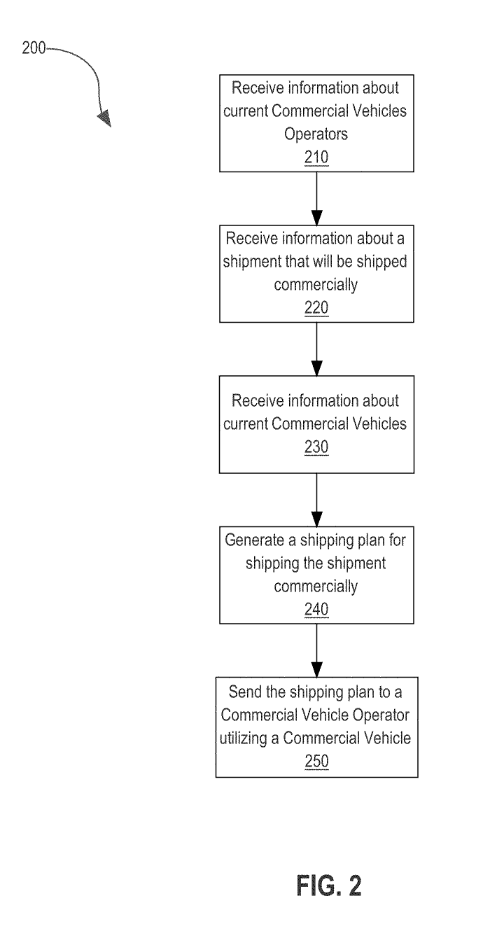

For example, device 120 may be a smartphone employed by a commercial vehicle operator to store and send information relating to the commercial vehicle operator over network 160. As a further example, device 121 may be servers or computing devices which store, for access, various data, such as data included in vehicle database 140. In an additional example, personal computer device may be used to view, store, or send information. ELD device 123 may be integrated into a commercial vehicle and may sending information relating the commercial vehicle over network 160. In various embodiments, the example system 100 as described herein executes the steps of process 200 in FIG. 2.

### Process Overview

FIG. 2 depicts an example process 200 that may govern operation of an embodiment. Process 200 begins with receiving 210 information about current commercial vehicle operators. Data is then received 220 about a shipment. Information about current commercial vehicles is received 230. Based on the received information relating to commercial vehicles, commercial vehicles operators, and a shipment, a shipping plan is generated 240. The generated shipping plan is then sent 250 to a particular commercial vehicle operator operating a commercial vehicle.

Returning to step 210, information relating to a plurality of commercial vehicle operators is received. In various embodiments, the information relating to commercial vehicle operators is obtained from one or more of user devices 120-123. For example, a commercial vehicle operator utilizing a mobile application on device 120 may have information relating to the commercial vehicle operator stored in the mobile application. The information may be collected by the activity monitor 110 and/or retrieved by the work distributor 150 to perform the generation of the shipping plan. The information relating to a plurality of commercial vehicle operators may be any information sufficient to convey attribute values of a commercial vehicle operator, such an operator's current location, time driven, origin location, destination location, rating, employment company, or any other information which may be used in the generation of a shipping plan.

At step 220, information is received relating to a shipment. A shipment may be a single object or a group of objects which is the subject of a commercial transaction that requires commercial shipping from one location to another location. In various embodiments, a management facility receives a shipment and inputs information about the shipment from a user device, such as device 120 and/or 122. In various embodiments, the shipment information may be sent to activity monitor 110 or and/or retrieved by the work distributor 150 to perform the generation of the shipping plan. The information relating to the shipment may be any information sufficient to convey some aspect of the shipment, such as the shipments designation code, location, destination, objects comprising the shipment, country of origin, management facility or storage, or any other information which may be used in the generation of a shipping plan.

At step 230, information is received relating to a plurality of commercial vehicles. A commercial vehicle may be any object, entity, vehicle or mode of transportation capable of transporting an object from one location to another location. In various embodiments, the information relating to a plurality of commercial vehicles is received from a plurality of EDL device installed and operating from the plurality of commercial vehicles. In various further embodiments, an EDL such as device 123 may send commercial vehicle information to activity monitor 110 and/or work distributor 150 to perform the generation of the shipping plan. The information relating to the plurality of commercial vehicles may be any information sufficient to convey some aspect of the commercial vehicle, such as Global Positioning Satellite (GPS) coordinates, miles driven in a day, weight capacity, current Rotations per Minute (RPM), last service date, or any other information which may be used in the generation of a shipping plan.

At step 240, a shipping plan is generated for transporting the shipment from one location to another using a commercial vehicle. A shipping plan may be any sequential set of directions or instructions such that when followed, allow for the transportation of a shipment from one location to another. An electronic shipping plan generated by system 100 may use data maintained by system 100 to create a digital representation of instructions which can be viewed and shared using electronic devices. Electronic shipping plans have the advantage of being easily viewable, sharable, modifiable, and/or interactive compared to traditional plans, such as those written manually on paper. The maintenance of digital data in electronic systems such as system 100 allows for generation of more efficient and accessible shipping plans by employing entities which can create, store, delete and manage data which is used in the generation of a shipping plan.

In various embodiments, multiple aspects of the received information relating to commercial vehicles, commercial vehicle operators and shipments is analyzed to determine to desirability of employing a commercial vehicle, and/or commercial vehicle operator in transporting the shipment. In various further embodiments, a score is calculated based on the total desirability of the multiple aspects of the received information. In various embodiments, multiple shipping plans are generated. In various further embodiments, a generated shipping plan having the highest calculated score is selected as a preferred shipping plan.

In various embodiments, some aspects of the received data are parameterized and given importance ratings which affect the selected of a generated plan. For example, a dispatcher may specify that the selection of a more experienced commercial vehicle operator is more important than selecting a commercial vehicle operator who will transport a shipment for the least amount of cost to a management facility. As a result, the work distributor 150 may automatically select a plan in which an experienced commercial vehicle operator transports the shipment despite a higher cost of work.

In various embodiments, generating a shipping plan is based on selecting a commercial vehicle operator based on a certification that the commercial vehicle operator has attained, and the shipment requires that an operator transporting the shipment has attained the certification. In various embodiments, generating a shipping plan is based on selecting a commercial vehicle operator based on a desirability rating of the commercial vehicle operator. For example, an attribute value relating to a commercial vehicle operator may include a value corresponding to a rating of the operator. Better reviewed and therefore more desirable commercial vehicle operators may have a higher rating value that is accounted for in generating the shipping plan.

At step 250, the shipping plan is relayed to a designated commercial vehicle operator specified in the shipping plan. In various embodiments, the commercial vehicle operator who receives the shipping plan is also the operator of a commercial vehicle specified in the shipping plan. In various further embodiments, the shipping plan is sent to both the commercial vehicle operator and a third party, such as the operators employment company, or a partner operator who will assist the operator in transporting the shipment. The shipping plan may be relayed to the commercial vehicle operator in any manner sufficient that the commercial vehicle operator may understand and follow the shipping plan. For example, the plan may be sent to a commercial vehicle operator through the mobile application on a mobile device such as device 120 as described above.

In various embodiments not pictured in FIG. 2, the generated shipping plan may include time constraints as part of the shipping plan. For example, the shipping plan may require that a shipment be delivered within a defined window of time. In various embodiments, the work distributor 150 will select specific times for pick-up and delivery of a shipment corresponding to logistical scenarios. For example, the work distributor may detect that traffic is present near a management facility based on vehicle information determined from the vehicle database and generate a shipping plan which is designed to be carried out at a time when traffic is not present.

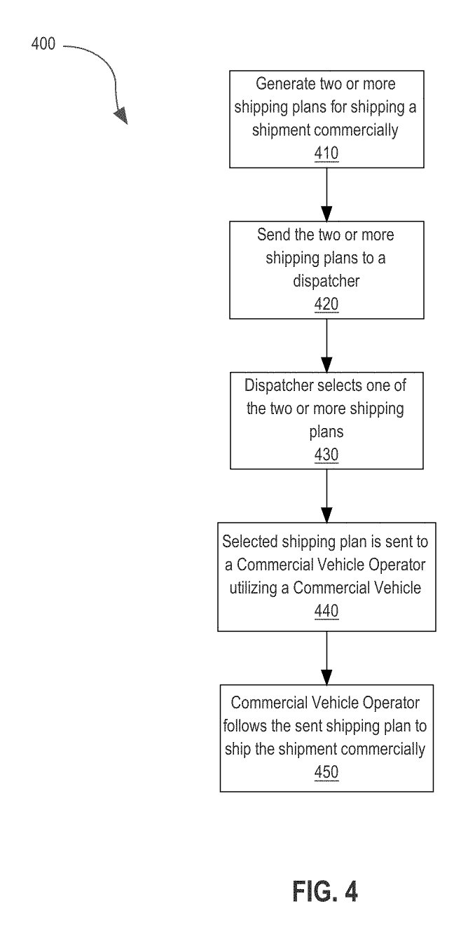

FIG. 4 depicts an example process 400 that may govern operation of an embodiment. Process 400 building on process 200 by including a dispatcher in a decision-making process which will aid in the relaying of a shipping plan to a commercial vehicle operator. Process 400 begins by generating 410 two or more candidate shipping plans in a manner similar to step 240. The two or more candidate shipping plans are then sent 420 to a dispatcher for selection 430 of a single plan for transporting the shipment. Following selection, the selected shipping plan is relayed 440 to the commercial vehicle operator specified in the shipping plan, who will carry out 450 the specified shipping plan.

Returning to step 410, two or more shipping plans are generated. The two or more shipping plans may each contain no overlapping data or some overlapping data. For example, first generated shipping plan may specify a commercial vehicle operator transport the shipment using a first commercial vehicle and a second generated shipping plan may specify that the same commercial vehicle operator transport the shipment using a second commercial vehicle.

At step 420, the two or more shipping plans are sent to a dispatcher. A dispatcher may be a human with the authority to select shipping plans for commercial vehicle operators. In various embodiments, a dispatcher is a device or computer which automatically performs a review of multiple shipping plans. In various embodiments, the shipping plans are received at dispatcher device 160.

At step 430, the dispatcher selects one of the two or more shipping plans which will become the selected shipping plan. In various embodiments, the dispatcher is human who manually selects one plan based on the dispatcher's personal preferences. In various embodiments, the dispatcher is a computer system programmed to select a shipping plan based on particular criteria. For example, a computer dispatcher may receive two or more shipping plans at step 420, perform an analysis of the two or more plans, such as a cost-benefit analysis, and automatically select one of the two or more plans based on the criteria, such as selecting the plan with the highest cost-benefit value.

At step 440, the selected shipping plan is sent to a commercial vehicle operator utilizing a commercial vehicle. In various embodiments, the commercial vehicle operator is sent the selected shipping plan along with other unselected shipping plans along with an indicator that the selected shipping plan was the plan selected. In various embodiments, the dispatcher sends the selected shipping plan from the dispatcher device 160 to the commercial vehicle operator. In various embodiments, the selected shipping plan is sent from the work distributor 150 to the commercial vehicle operator in response to receiving an indication from the dispatcher device 160 that the selected shipping plan has been selected.

At step 450, the commercial vehicle operator follows the selected shipping plan to complete the transportation of the shipment. In various embodiments, the selected shipping plan can be replaced with one of the unselected shipping plans in response to a request from the commercial vehicle operator or the dispatcher. In various embodiments, the selected shipping plan is modified in whole or in part in response to a request from the commercial vehicle operator or the dispatcher. In various embodiments modifications to the shipping plan occur in automatically in response to information received at system 100. For example, in response to determining the location of a commercial vehicle transporting a shipment is not in a preferred location according to the selected shipping plan, the selected shipping plan may be modified to allow the commercial vehicle operator to allow the commercial vehicle onto toll-roads to save preserve the selected shipping plan's time table at the cost of increasing shipping fees associated with using toll-roads.

### Example Embodiments

FIG. 4 depicts an example embodiment that may be used in implementing the example processes. Specifically, FIG. 4 depicts a map of commercial vehicles in the vicinity of a management facility. Management facility 400 receives and processes shipments 410 which will be transported by a commercial vehicle. Commercial vehicles 420 and 430 are currently different distances from management facility 400. In various embodiments, distance to a management facility may be one factor which work distributor 150 will account for in the generation of a shipping plan.

For example, an ELD device 123 in commercial vehicles 420 and 430 may send information relating the current GPS coordinates of the respective vehicles to vehicle database 140. Work distributor 150 may obtain the GPS coordinates and factor in the current distance from the management facility 400 to pick up a shipment 410. The work distributor may determine that commercial vehicle 420 is close to management facility 400 than commercial vehicle 430. As a result, the work distributor will generate a shipping plan which utilizes commercial vehicle 420 to transport shipment 410 to save time for both the management facility and the commercial vehicle operator operating commercial vehicle 420.

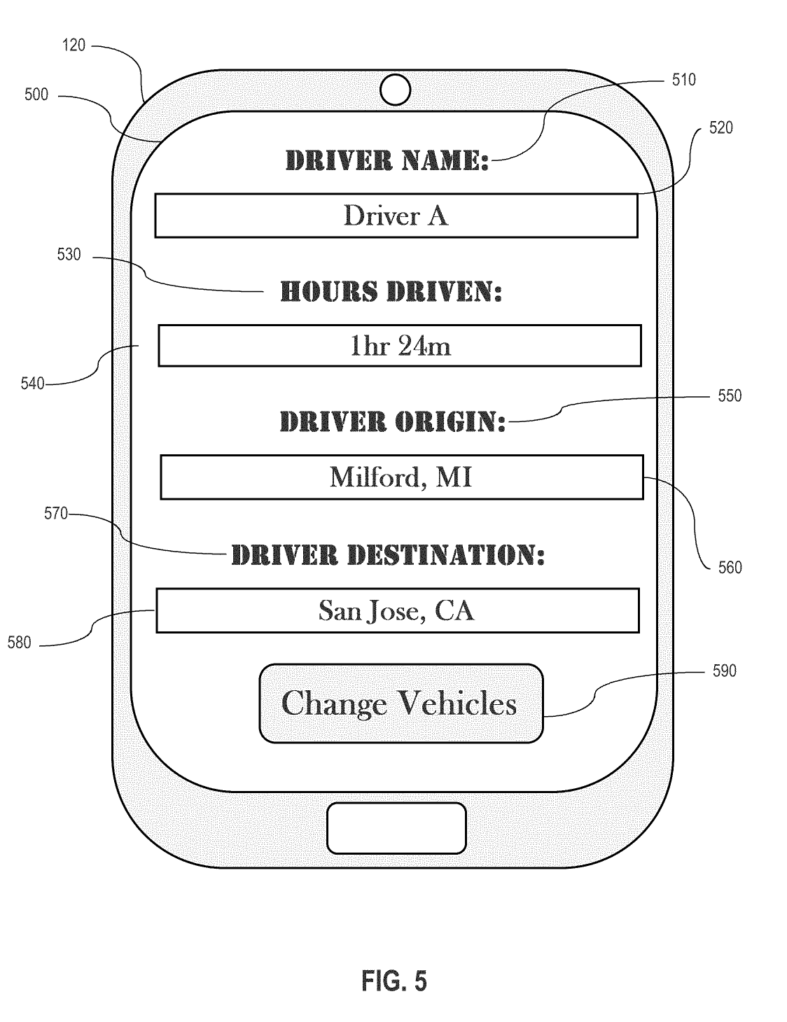

FIG. 5 depicts an example embodiment that may be used in implementing the example processes. Specifically, FIG. 5. depicts device 120 being utilized as a user mobile device for the tracking of information relating to a commercial vehicle operator. Device 120 has a screen 500 which implements a graphical user interface as part of a mobile application running on device 120. The graphical user interface may comprise any information necessary to convey to a commercial vehicle operator the current status of some aspect of the commercial vehicle operator. Device 120 may track and store any information which is sufficient to convey some aspect of the commercial vehicle operator to the activity monitor 110.

As depicted in FIG. 5, one aspect that may be tracked is the name of the commercial vehicle operator. A signifier of the operator's name 510 may be shown on the screen 500 of device 120 along with a name field 520 specifying the operator's name. For example, FIG. 5 shows DRIVER A as the driver associated with the displayed mobile application. As depicted in FIG. 5, one additional aspect that may be tracking is the current hours drive by the operator. A signifier of the operator's hours drive 530 may be shown along with an hours field 540 specifying the number of continuous hours the operator has operated a commercial vehicle. For example DRIVER A's hours driven continuously is 1 hour and 24 minutes of driving time. A signifier of the operator's current origin 550, or city of departure to transport a shipment, may be shown along with an origin field 560 specifying the operator's current origin location. For example, DRIVER A's city of origin is listed as Milford, Mich. A signifier of the operator's current destination 570, or city for completing transportation may be shown along with a destination field 580 specifying the operator's current destination location. For example, DRIVER A's city destination is listed as San Jose, Calif. In various embodiments, device 120 may display information on screen 500 which is not sent to the activity monitor 110 or may send information to the activity monitor 110 that is not displayed on the screen 500.

In various embodiments, a user account may be associated with the mobile application on device 120. For example, a user account may correspond to a commercial vehicle operator in a one-to-one relationship, such that a single commercial vehicle operator may utilize any number of devices running the mobile application. By associating a mobile application with the user account of the operator, the commercial vehicle operator can track their information from any device.

In various embodiments, system 100 associates a particular commercial vehicle operator with a particular commercial vehicle to generate shipping plans. The association between a commercial vehicle operator and a commercial vehicle may improve the system's ability to generate efficient and cost-effective plans. Additionally, in instances in which a commercial vehicle operator must change association with a commercial vehicle due to circumstances like required maintenance, accidents, or employment changes, associations of a commercial vehicle operator with a new commercial vehicle are essential. FIG. 5 depicts an interactive button vehicle change button 590 by which an operator may change their association with a commercial vehicle through the mobile application.

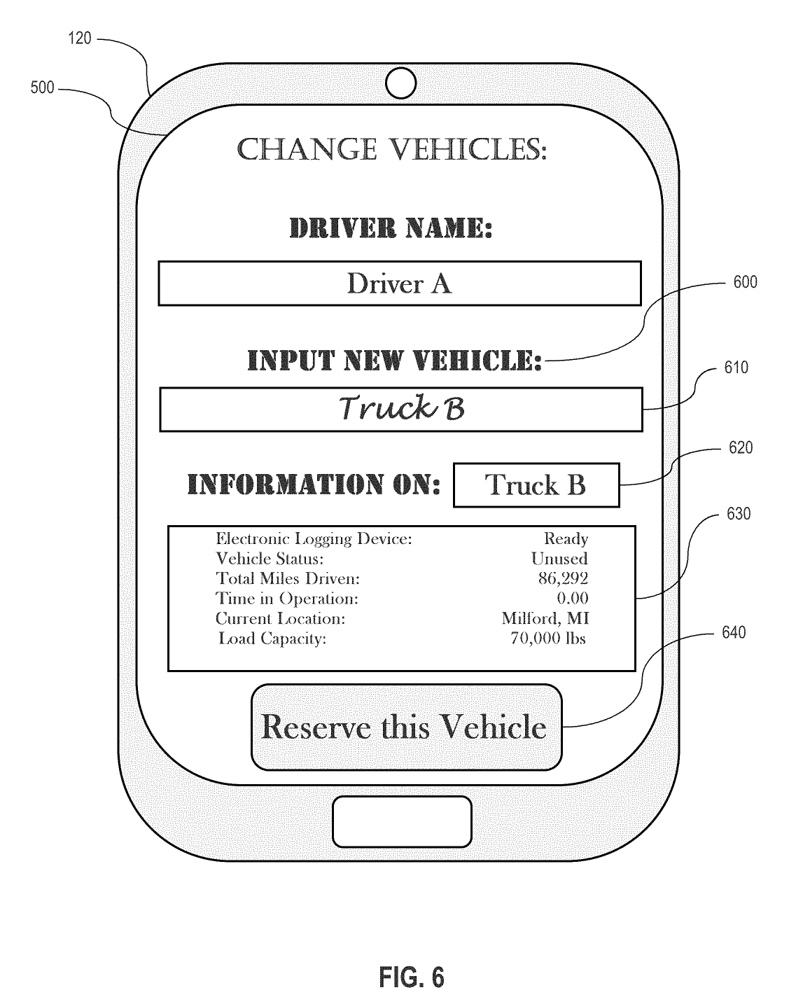

As depicted in FIG. 6, a commercial vehicle operator may change their association with a particular commercial vehicle. In various embodiments, the operator may use the same device 120 utilizing a screen 500 to make changes to the associated vehicle. A change prompt 610 may request input from a user in a change field 610. The mobile application may accept an operator input in change field 620 corresponding to a particular identification code, name or other signifier which specifies a particular commercial vehicle. For example, DRIVER A has input TRUCK B as the associated new vehicle.

Once the operator input has been input into the change field 620, the mobile application at device 120 may display certain information associated with the specified commercial vehicle. In various embodiments the displayed information is a subset of vehicle information stored in the vehicle database 140. For example, signifier of vehicle information 620 displays information 630 on TRUCK B, which has been selected by DRIVER A. In various embodiments, an association will not be made until confirmation of the change is made by an operator such as pressing a reservation button 640 to complete the association.

In various embodiments, in response to a new association of a commercial vehicle operator being made to a commercial vehicle, a device may send an indication to the activity monitor 110 that the operator is now associated with the commercial vehicle. For example, in response to DRIVER A reserving TRUCK B by pressing reservation button 640, device 120 may send an indication to activity monitor 110 that DRIVER A is now operating TRUCK B. The activity monitor may pass this information to work distributor 150 to generate more accurate shipping plans.

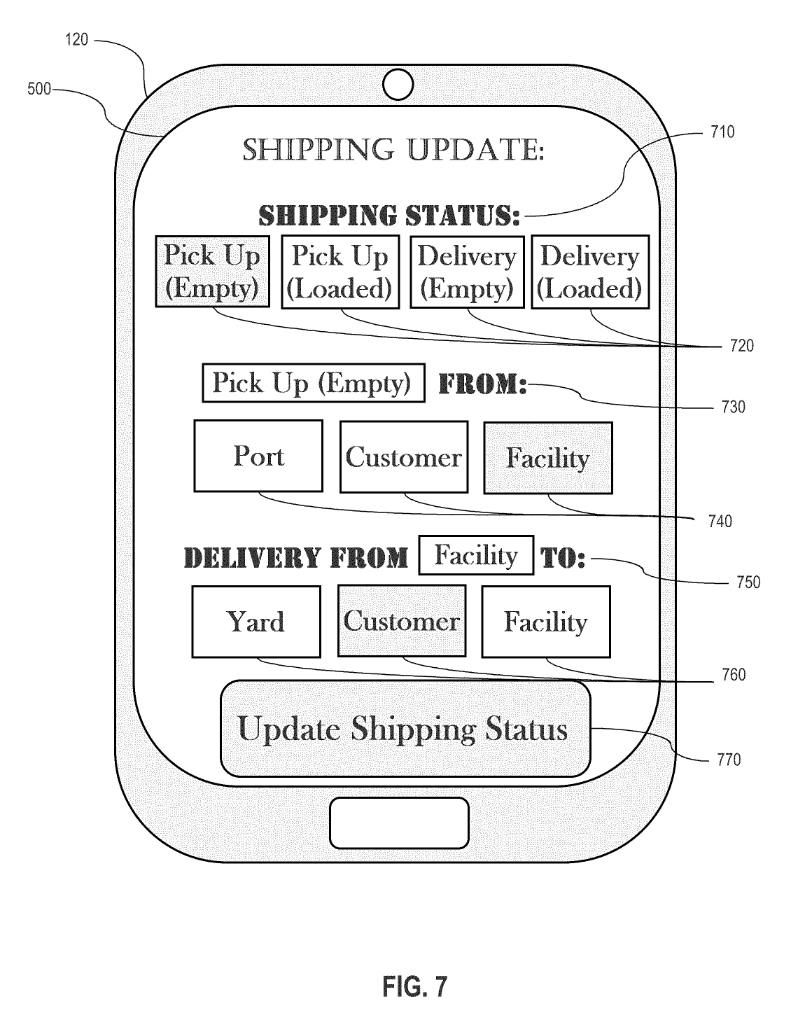

As depicted in FIG. 7, a commercial vehicle operator may update status information relating to a scheduled delivery at any time, prior to, during, or subsequent to the execution of a delivery plan. In various embodiments, the operator may use the same device 120 utilizing a screen 500 to make changes to the operator's current status. For example, a commercial vehicle operator may relay information to device 120 which may in turn be relayed to activity monitor 110 and/or to a shipping company employing the operator. In various embodiments, current status information may be sent to a management facility, logistics tracking service, delivery origin entity, or delivery destination entity at any time prior to, during, or subsequent to the execution of the delivery plan.

As depicted in FIG. 7, a status prompt 710 may request input from a commercial vehicle operator to select from one or more status fields 720 to indicate the current status of the operator. For example, a driver who is currently en-route to pick up a shipment in a commercial vehicle unoccupied by any other shipment may update the shipping status by selecting a field such as PICK UP (EMPTY) on screen 500. Additional status fields may indicate that a driver is en-route to pick up a shipment in a commercial vehicle which is currently occupied with at least one other shipment. Other additional status fields may indicate that a driver is en-route to a delivery location in a commercial vehicle which is currently unoccupied or occupied with a shipment.

A commercial vehicle operator may further configure a shipping update to include information on the type of entity which the operator is en-route to and/or the type of entity which the operator will ultimately complete a delivery at. A first entity prompt 730 may request input from a user to select from one or more first entity fields 740. The first entity fields 740 may specify the type of entity an operator is currently en-route to. For example, a commercial vehicle operator en-route to a management facility may select a first entity field titled FACILITY. In various embodiments, the first entity prompt 730 may change depending on one or more selected status fields 720.

A second entity prompt 750 may request input from a user to select from one or more second entity fields 760. The second entity fields 760 may specify the type of entity an operator will ultimately complete a shipping plan at. For example, a commercial vehicle operator following a shipping plan directing that operator to deliver a shipment directly to a customer may select a second entity field 760 title CUSTOMER. In various embodiments, the second entity prompt 730 may change depending on one or more selected status fields 720 and/or first entity fields 740.

In various embodiments, status information is not updated or sent to any entities until a user finalizes the shipping update. For example, a user may select any of the status fields 720, first entity fields 740 and/or second entity fields 760, but device 120 may not allow the sending of the status information until a user has pressed an update status button 770 to confirm the current status of the commercial vehicle operator.

In various embodiments, updating status information in done prior to receiving a shipping plan to aid in the generation of an appropriate shipping plan. For example, a commercial vehicle operator in a landlocked state currently awaiting a new shipping plan may select a status field 720 of PICK UP (EMPTY) and a first entity field 740 of FACILITY to indicate the operator's desire to receive a shipping plan which specifies picking up a shipment at a management facility. Alternatively, a commercial vehicle operator in a coastal state and desiring a shipping plan to supplement a concurrent shipping plan may select a status field 720 of PICK UP (LOADED) and a first entity field 740 of PORT to indicate the operators desire to receive a supplementary shipping plan which specifies picking up an additional shipment from a port. In various further embodiments, the work distributor 150 receives the status information of commercial vehicle operators and uses the information to generate shipping plans. In various further embodiments, the work distributor 150 will not generate a shipping plan until status information is updated to indicate that a commercial vehicle operator is ready to accept a shipping plan.

In various embodiment, entities other than the commercial vehicle operator may receive status information input by the operator. A dispatcher utilizing device 122 may access a web portal configured to display status information sent from various operators. The dispatcher may view the status information sent by a specific operator by searching for a name field 520 of the specific operator. For example, a dispatcher may view status information indicating that a commercial vehicle operator for whom the dispatcher recently approved a shipping plan has updated their status information to indicate the operator in en-route to a facility to pick up of the shipment. In various embodiments, various entities such as employers, logistics management companies, customers, law enforcement authorities, etc. may have access to a web-portal displaying the information status of a commercial vehicle operator.

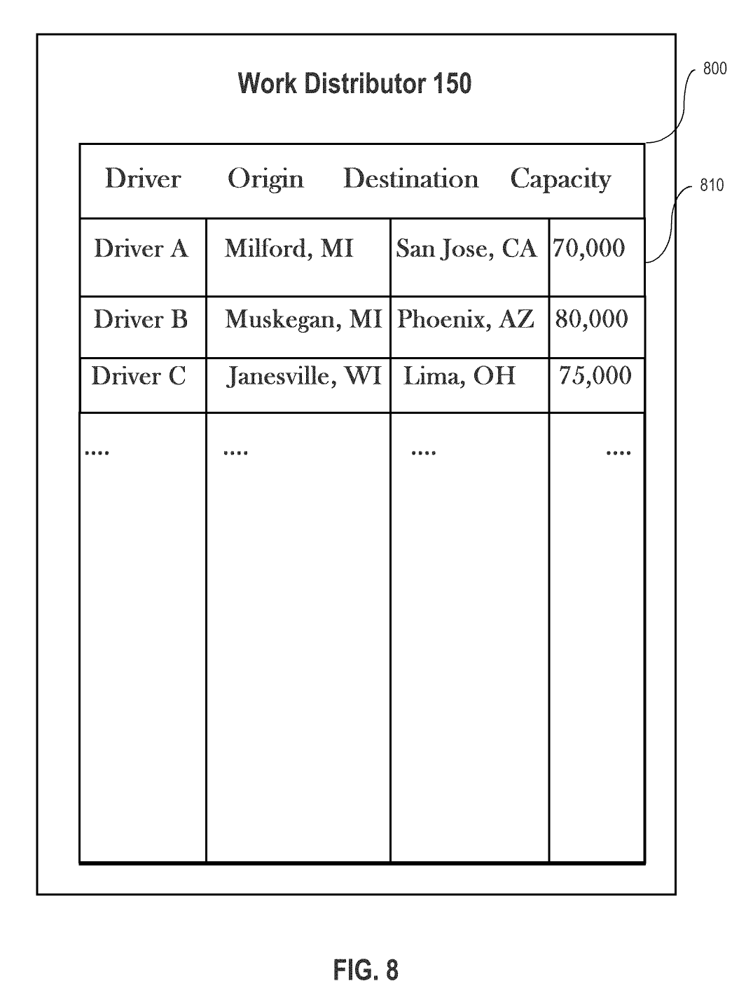

As depicted in FIG. 8, the work distributor 150 may comprise data corresponding to aspects of commercial vehicle operators, commercial vehicles and shipments. The data may be grouped to reflect current associations between data and any combination of data sufficient to generate a shipping plan is possible. As depicted in FIG. 8, the work distributor may group information in an information group 800 related to an operator, the operator's origin, the operator's destination, and the carrying capacity of a commercial vehicle which the operator is currently associated with. For example, in response to DRIVER A associating with TRUCK B, the work distributor may regroup data accordingly by including data value 810, the carrying capacity of 70,000 pounds associated with TRUCK B, specified by TRUCK B's ELD, in the grouped data corresponding to DRIVER A.

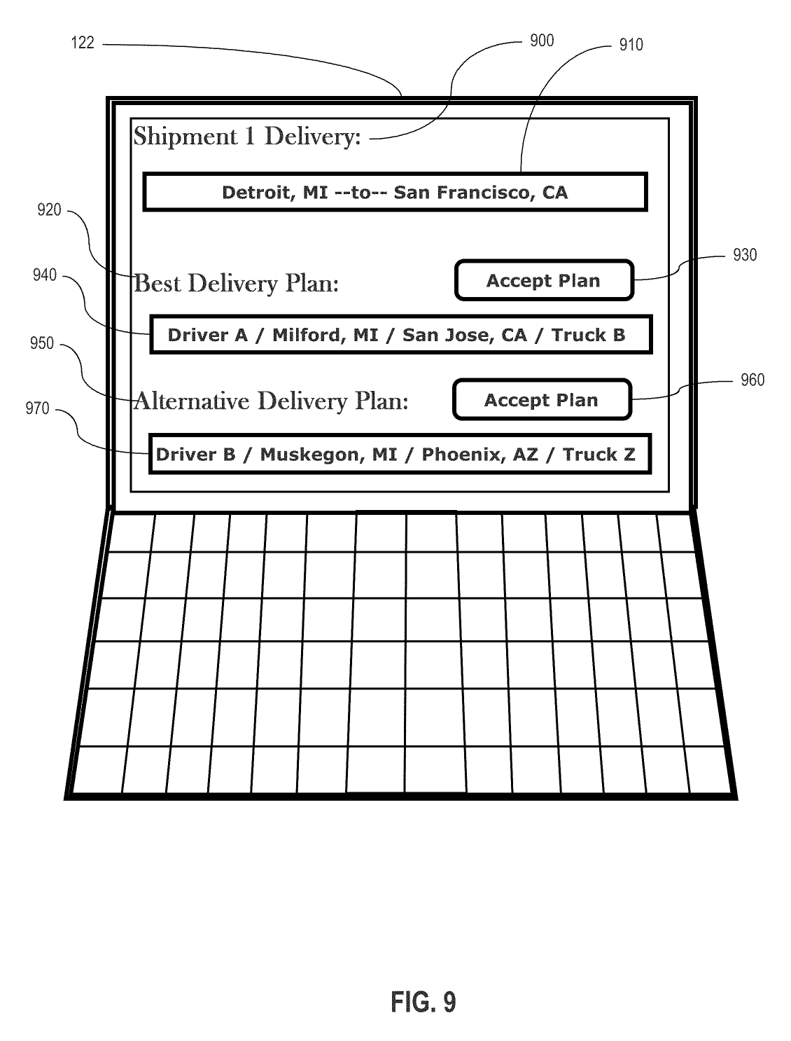

As depicted in FIG. 9, a separate device, such as device 122, may be used by a dispatcher to select one of two or more generated plans according to process 400. For example, device 122 may display, to a human dispatcher, elements of a shipment and generated shipping plans to aid in the selection of a shipping plan to relay to a commercial operator. The information displayed to the dispatcher may be any information sufficient to allow a dispatcher to select a shipping plan. For example, a signifier of a shipment 900, SHIPMENT 1, is displayed to a dispatcher along with a shipment field 910 specifying details of the shipment.

Once the work distributor 150 has generated two or more shipping plans in step 410, the two or more shipping plans may be displayed to the dispatcher. The display of the plans may depend of which shipping plan was determined to be more desirable at the time of generation. A preferred shipping plan may be displayed by a signifier of the preferred shipping plan 920 followed by a preferred field 940 showing information on the generated shipping plan. An accept plan button 930 may allow a dispatcher to manually select the preferred plan, causing the preferred plan to be relayed to the commercial vehicle operator as in step 440.

For example, SHIPMENT 1 specifies a shipment leaving Detroit, Mich. and being transported to San Francisco, Calif. The work distributor may determine DRIVER A utilizing TRUCK B, currently in Milford, Mich., and with a destination of San Jose, Calif., to be the best candidate operator for taking on an additional shipment, namely SHIPMENT 1. If the dispatcher agrees, the dispatcher may accept the preferred shipping plan with the accept button 930. Alternatively, the dispatcher may determine that DRIVER A is not preferable for some reason. As depicted in FIG. 9, a signifier of an alternative shipping plan 950 may indicate an alternative field 970 showing another generated shipping plan. The dispatcher may decide to allow the alternative shipping plan by pressing the accept button 960 associated with the alternative shipping plan. For example even though DRIVER B's origin and destination are farther from SHIPMENT 1's origin and destination cities, the dispatcher's selection of the alternative shipping plan may be more preferable by sacrificing shipping time for other considerations such as DRIVER B's reliability, cost, or special certification.

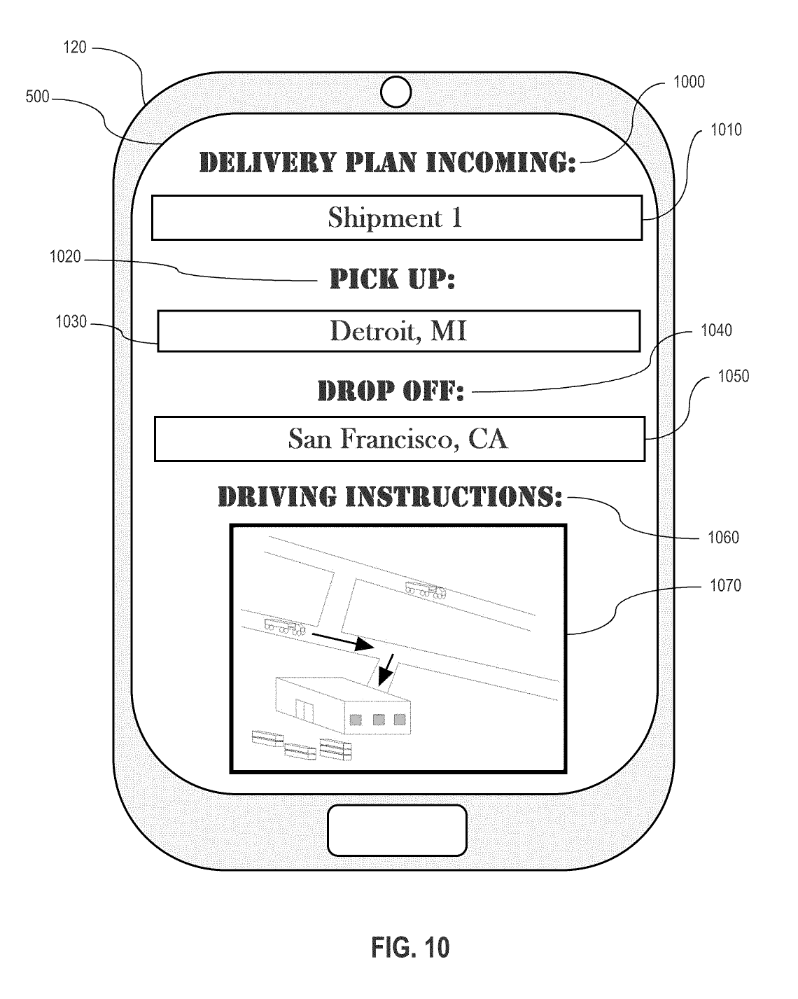

As depicted in FIG. 10, once a shipping plan has been selected or generated, it is sent to a commercial vehicle operator. In various embodiments, the shipping plan is sent to a device utilized by the operator, such as device 120. In various embodiments, in response to sending the shipping plan to the commercial vehicle operator, the device may display the shipping plan on the users screen 500. Sending the shipping plan to the commercial vehicle operator may comprise sending any amount of information to the commercial vehicle operator sufficient to allow the operator to carry out the plan. For example, as depicted in FIG. 10, a signifier of the delivery plan 1000 may specify that a shipping plan has been added to the commercial vehicle operator's transportation itinerary. A shipment name field 1010 may specify some information about the shipment which is the subject of the shipping plan.

A plan origin signifier 1020 may precede a plan origin field 1030 specifying where a commercial vehicle operator is going to pick up a shipment. Similarly, a plan destination signifier 1040 may precede a plan destination field 1050 specifying where a commercial vehicle operator is going to drop of a shipment. For example, in response to the selection of the preferred shipping plan with acceptance button 930, DRIVER A is sent the shipping plan and SHIPMENT 1 is displayed in shipment name field 1010. Detroit, Mich. and San Francisco, Calif. are displayed in origin field 1030 and destination field 1050 respectively.

In various embodiments a map or other instruction to carry out shipping plan is displayed to the commercial vehicle operator. An instruction signifier 1060 may precede a map field 1070 showing commercial vehicle operator instructions for carrying out the shipping plan. For example, a map may show DRIVER A, at device 120, a map for picking up a shipment in Detroit, Mich. and may further show instructions for transporting the shipment to San Francisco, Calif. In various embodiments, a commercial vehicle operator confirms to system 100 that the shipping plan instructions have been received at device 120. In various embodiments, an invoice or bill of sale may be digitally generated in response to confirmation that a commercial vehicle operator has completed all steps specified in a delivery plan.

### Implementation Mechanisms

According to one embodiment, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques, or may include digital electronic devices such as at least one application-specific integrated circuit (ASIC) or field programmable gate array (FPGA) that is persistently programmed to perform the techniques, or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

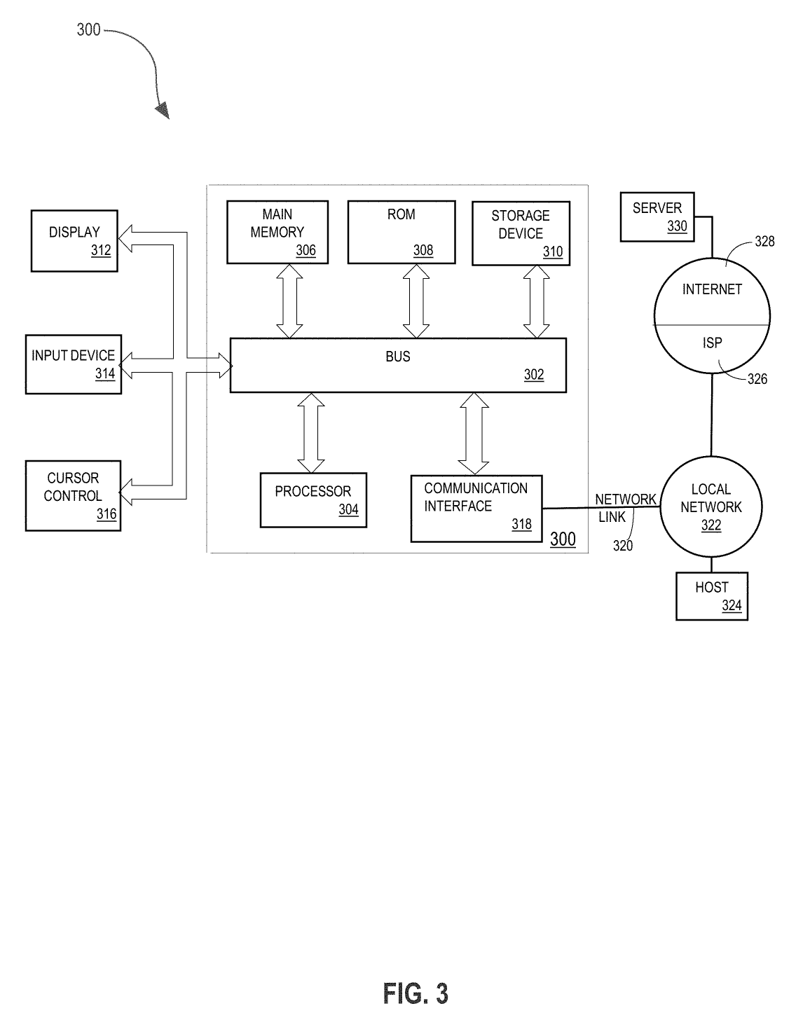

FIG. 3 is a block diagram that depicts an example computer system with which an embodiment may be implemented. In the example of FIG. 3, a computer system 300 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 300 includes an input/output (I/O) subsystem 302 which may include a bus and/or other communication mechanism(s) for communicating information and/or instructions between the components of the computer system 300 over electronic signal paths. The I/O subsystem 302 may include an I/O controller, a memory controller and at least one I/O port. The electronic signal paths are represented schematically in the drawings, for example as lines, unidirectional arrows, or bidirectional arrows.

At least one hardware processor 304 is coupled to I/O subsystem 302 for processing information and instructions. Hardware processor 304 may include, for example, a general-purpose microprocessor or microcontroller and/or a special-purpose microprocessor such as an embedded system or a graphics processing unit (GPU) or a digital signal processor or ARM processor. Processor 304 may comprise an integrated arithmetic logic unit (ALU) or may be coupled to a separate ALU.

Computer system 300 includes one or more units of memory 306, such as a main memory, which is coupled to I/O subsystem 302 for electronically digitally storing data and instructions to be executed by processor 304. Memory 306 may include volatile memory such as various forms of random-access memory (RAM) or other dynamic storage device. Memory 306 also may be used for storing temporary variables or other intermediate information during execution of instructions to be executed by processor 304. Such instructions, when stored in non-transitory computer-readable storage media accessible to processor 304, can render computer system 300 into a special-purpose machine that is customized to perform the operations specified in the instructions.

Computer system 300 further includes non-volatile memory such as read only memory (ROM) 308 or other static storage device coupled to I/O subsystem 302 for storing information and instructions for processor 304. The ROM 308 may include various forms of programmable ROM (PROM) such as erasable PROM (EPROM) or electrically erasable PROM (EEPROM). A unit of persistent storage 310 may include various forms of non-volatile RAM (NVRAM), such as FLASH memory, or solid-state storage, magnetic disk or optical disk such as CD-ROM or DVD-ROM and may be coupled to I/O subsystem 302 for storing information and instructions. Storage 310 is an example of a non-transitory computer-readable medium that may be used to store instructions and data which when executed by the processor 304 cause performing computer-implemented methods to execute the techniques herein.

The instructions in memory 306, ROM 308 or storage 310 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer and data storage layer such as a relational database system using structured query language (SQL) or no SQL, an object store, a graph database, a flat file system or other data storage.

Computer system 300 may be coupled via I/O subsystem 302 to at least one output device 312. In one embodiment, output device 312 is a digital computer display. Examples of a display that may be used in various embodiments include a touch screen display or a light-emitting diode (LED) display or a liquid crystal display (LCD) or an e-paper display. Computer system 300 may include other type(s) of output devices 312, alternatively or in addition to a display device. Examples of other output devices 312 include printers, ticket printers, plotters, projectors, sound cards or video cards, speakers, buzzers or piezoelectric devices or other audible devices, lamps or LED or LCD indicators, haptic devices, actuators or servos.

At least one input device 314 is coupled to I/O subsystem 302 for communicating signals, data, command selections or gestures to processor 304. Examples of input devices 314 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 316, which may perform cursor control or other automated control functions such as navigation in a graphical interface on a display screen, alternatively or in addition to input functions. Control device 316 may be a touchpad, a mouse, a trackball, or cursor direction keys for communicating direction information and command selections to processor 304 and for controlling cursor movement on display 312. The input device may have at least two degrees of freedom in two axes, a first axis, for example, x, and a second axis, for example, y, that allows the device to specify positions in a plane. Another type of input device is a wired, wireless, or optical control device such as a joystick, wand, console, steering wheel, pedal, gearshift mechanism or other type of control device. An input device 314 may include a combination of multiple different input devices, such as a video camera and a depth sensor.

In another embodiment, computer system 300 may comprise an internet of things (IoT) device in which one or more of the output device 312, input device 314, and control device 316 are omitted. Or, in such an embodiment, the input device 314 may comprise one or more cameras, motion detectors, thermometers, microphones, seismic detectors, other sensors or detectors, measurement devices or encoders and the output device 312 may comprise a special-purpose display such as a single-line LED or LCD display, one or more indicators, a display panel, a meter, a valve, a solenoid, an actuator or a servo.

When computer system 300 is a mobile computing device, input device 314 may comprise a global positioning system (GPS) receiver coupled to a GPS module that is capable of triangulating to a plurality of GPS satellites, determining and generating geo-location or position data such as latitude-longitude values for a geophysical location of the computer system 300. Output device 312 may include hardware, software, firmware and interfaces for generating position reporting packets, notifications, pulse or heartbeat signals, or other recurring data transmissions that specify a position of the computer system 300, alone or in combination with other application-specific data, directed toward host 324 or server 330.

Computer system 300 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to one embodiment, the techniques herein are performed by computer system 300 in response to processor 304 executing at least one sequence of at least one instruction contained in main memory 306. Such instructions may be read into main memory 306 from another storage medium, such as storage 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage 310. Volatile media includes dynamic memory, such as memory 306. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 302. Transmission media can also take the form of acoustic or light waves, such as those generated during radio-wave and infra-red data communications.

Various forms of media may be involved in carrying at least one sequence of at least one instruction to processor 304 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 300 can receive the data on the communication link and convert the data to a format that can be read by computer system 300. For instance, a receiver such as a radio frequency antenna or an infrared detector can receive the data carried in a wireless or optical signal and appropriate circuitry can provide the data to I/O subsystem 302 such as place the data on a bus. I/O subsystem 302 carries the data to memory 306, from which processor 304 retrieves and executes the instructions. The instructions received by memory 306 may optionally be stored on storage 310 either before or after execution by processor 304.

Computer system 300 also includes a communication interface 318 coupled to bus 302. Communication interface 318 provides a two-way data communication coupling to network link(s) 320 that are directly or indirectly connected to at least one communication networks, such as a network 322 or a public or private cloud on the Internet. For example, communication interface 318 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 322 broadly represents a local area network (LAN), wide-area network (WAN), campus network, internetwork or any combination thereof. Communication interface 318 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 318 sends and receives electrical, electromagnetic or optical signals over signal paths that carry digital data streams representing various types of information.

Network link 320 typically provides electrical, electromagnetic, or optical data communication directly or through at least one network to other data devices, using, for example, satellite, cellular, Wi-Fi, or BLUETOOTH technology. For example, network link 320 may provide a connection through a network 322 to a host computer 324.

Furthermore, network link 320 may provide a connection through network 322 or to other computing devices via internetworking devices and/or computers that are operated by an Internet Service Provider (ISP) 326. ISP 326 provides data communication services through a world-wide packet data communication network represented as internet 328. A server computer 330 may be coupled to internet 328. Server 330 broadly represents any computer, data center, virtual machine or virtual computing instance with or without a hypervisor, or computer executing a containerized program system such as DOCKER or KUBERNETES. Server 330 may represent an electronic digital service that is implemented using more than one computer or instance and that is accessed and used by transmitting web services requests, uniform resource locator (URL) strings with parameters in HTTP payloads, API calls, app services calls, or other service calls. Computer system 300 and server 330 may form elements of a distributed computing system that includes other computers, a processing cluster, server farm or other organization of computers that cooperate to perform tasks or execute applications or services. Server 330 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server 330 may comprise a web application server that hosts a presentation layer, application layer and data storage layer such as a relational database system using structured query language (SQL) or no SQL, an object store, a graph database, a flat file system or other data storage.

Computer system 300 can send messages and receive data and instructions, including program code, through the network(s), network link 320 and communication interface 318. In the Internet example, a server 330 might transmit a requested code for an application program through Internet 328, ISP 326, local network 322 and communication interface 318. The received code may be executed by processor 304 as it is received, and/or stored in storage 310, or other non-volatile storage for later execution.

The execution of instructions as described in this section may implement a process in the form of an instance of a computer program that is being executed and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening several instances of the same program often means more than one process is being executed. Multitasking may be implemented to allow multiple processes to share processor 304. While each processor 304 or core of the processor executes a single task at a time, computer system 300 may be programmed to implement multitasking to allow each processor to switch between tasks that are being executed without having to wait for each task to finish. In an embodiment, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

What is claimed is:

1. A computer-implemented method comprising:
receiving, at a computer system, first data specifying attribute values for a plurality of commercial vehicle operators;
receiving, at the computer system, second data specifying a shipment which will be commercially transported;
receiving, at the computer system, from a database system, vehicle data specifying a plurality of commercial vehicles, wherein each commercial vehicle from the plurality of commercial vehicles corresponds to a commercial vehicle operator from the plurality of commercial vehicles operators;
generating, by the computer system, and based on the first data, second data, and vehicle data, a shipping plan for transporting the shipment commercially, wherein the shipping plan comprises a designated commercial vehicle operator of the plurality of commercial vehicle operators;
sending, by the computer system, the shipping plan to a designated user device associated with the designated commercial vehicle operator.

2. The computer-implemented method of claim 1, further comprising:
sending, by the computer system, the shipping plan for approval to a dispatcher device;
in response to approval of the shipping plan, sending the shipping plan to the designated user device.

3. The computer-implemented method of claim 2, wherein:
generating the shipping plan comprises generating a plurality of candidate shipping plans based on the first data, second data and vehicle data;
sending the shipping plan to the dispatcher device comprises sending the plurality of candidate shipping plans to the dispatcher device;
approving the shipping plan at the dispatcher device comprises selecting one of the plurality of candidate shipping plans;
the shipping plan sent to the designated user device from the dispatcher device is the selected candidate shipping plan from the plurality of candidate shipping plans.

4. The computer-implemented method of claim 1, wherein:
the first data is sent from a plurality of user applications, where each user application from the plurality of user applications corresponds to a user account from a plurality of user accounts, wherein each user account from the plurality of user accounts corresponds to a commercial vehicle operator from the plurality of commercial vehicle operators;
sending the shipping plan to the designated user device comprises sending the shipping plan to the user application associated with the user account corresponding to the designated commercial vehicle operator from the plurality of commercial vehicle operators.

5. The computer-implemented method of claim 4, further comprising:
selecting, at a user application associated with a user account corresponding to a commercial vehicle operator, a commercial vehicle of the plurality of commercial vehicles to be associated with the commercial vehicle operator;
wherein generating the shipping plan is further based on the association between the one commercial vehicle operator and the selected one commercial vehicle.

6. The computer-implemented method of claim 1, further comprising:
displaying, on a graphical user interface on the designated user device, the shipping plan by displaying at least a map and instructions for completing one or more aspects of the shipping plan;
updating the graphical user interface in response to completing at least one aspect of the shipping plan.

7. The computer-implemented method of claim 1 wherein the first data includes an indicator of whether a commercial vehicle operator is certified to commercially transport the shipment, and further comprising selecting the designated commercial vehicle operator based, at least in part, on the indicator that the designated commercial vehicle operator is certified to transport the shipment.

8. The computer-implemented method of claim 1 wherein the first data includes a value specifying a time that a commercial vehicle operator has been operating a commercial vehicle, and further comprising selecting the designated commercial vehicle operator based, at least in part, on the value specifying the time that the designated commercial vehicle operator has been operating a commercial vehicle being less than a threshold time value.

9. The computer-implemented method of claim 1 wherein the first data includes a rating specifying a desirability of a commercial vehicle operator, and further comprising selecting the designated commercial vehicle operator based, at least in part, on the rating specifying the desirability of the designated commercial vehicle operator.

10. The computer-implemented method of claim 1 wherein the vehicle data includes a distance value specifying a current distance of a commercial vehicle from a location of the shipment, and further comprising selecting the designated commercial vehicle operator based, at least in part, on the distance value specifying the current distance of the commercial vehicle corresponding from the location of the shipment, wherein the commercial vehicle corresponds to the designated commercial vehicle operator.

11. One or more non-transient computer readable storage media comprising instructions which, when executed by a processor, cause the processor to:
receive, at a computer system, first data specifying attribute values for a plurality of commercial vehicle operators;
receive, at the computer system, second data specifying a shipment which will be commercially transported;
receive, at the computer system, from a database system, vehicle data specifying a plurality of commercial vehicles, wherein each commercial vehicle from the plurality of commercial vehicles corresponds to a commercial vehicle operator from the plurality of commercial vehicles operators;
generate, by the computer system, and based on the first data, second data, and vehicle data, a shipping plan for transporting the shipment commercially, wherein the shipping plan comprises a designated commercial vehicle operator of the plurality of commercial vehicle operators;
send, by the computer system, the shipping plan to a designated user device associated with the designated commercial vehicle operator.

12. The non-transient computer readable storage media of claim 11 further comprising instructions which, when executed by the processor cause the processor to:
send, by the computer system, the shipping plan for approval to a dispatcher device;
in response to approval of the shipping plan, send the shipping plan to the designated user device.

13. The non-transient computer readable storage media of claim 12, wherein:
generating the shipping plan comprises generating a plurality of candidate shipping plans based on the first data, second data and vehicle data;
sending the shipping plan to the dispatcher device comprises sending the plurality of candidate shipping plans to the dispatcher device;
approving the shipping plan at the dispatcher device comprises selecting one of the plurality of candidate shipping plans;
the shipping plan sent to the designated user device from the dispatcher device is the selected candidate shipping plan from the plurality of candidate shipping plans.

14. The non-transient computer readable storage media of claim 11, wherein:
the first data is sent from a plurality of user applications, where each user application from the plurality of user applications corresponds to a user account from a plurality of user accounts, wherein each user account from the plurality of user accounts corresponds to a commercial vehicle operator from the plurality of commercial vehicle operators;
sending the shipping plan to the designated user device comprises sending the shipping plan to the user application associated with the user account corresponding to the designated commercial vehicle operator from the plurality of commercial vehicle operators.

15. The non-transient computer readable storage media of claim 14 further comprising instructions which, when executed by the processor cause the processor to:
select, at a user application associated with a user account corresponding to a commercial vehicle operator, a commercial vehicle of the plurality of commercial vehicles to be associated with the commercial vehicle operator.
wherein generating the shipping plan is further based on the association between the one commercial vehicle operator and the selected one commercial vehicle;

16. The non-transient computer readable storage media of claim 11 further comprising instructions which, when executed by the processor cause the processor to:
display, on a graphical user interface on the designated user device, the shipping plan by displaying at least a map and instructions for completing one or more aspects of the shipping plan;
update the graphical user interface in response to completing at least one aspect of the shipping plan.

17. The non-transient computer readable storage media of claim 11 wherein the first data includes an indicator of whether a commercial vehicle operator is certified to commercially transport the shipment, and further comprising instructions which, when executed by the processor cause the processor to select the designated commercial vehicle operator based, at least in part, on the indicator that the designated commercial vehicle operator is certified to transport the shipment.

18. The non-transient computer readable storage media of claim 11 wherein the first data includes a value specifying a time that a commercial vehicle operator has been operating a commercial vehicle and further comprising instructions which, when executed by the processor cause the processor to select the designated commercial vehicle operator based, at least in part, on the value specifying the time that the designated commercial vehicle operator has been operating a commercial vehicle being less than a threshold time value.

19. The non-transient computer readable storage media of claim 11 wherein the first data includes a rating specifying a desirability of a commercial vehicle operator and further comprising instructions which, when executed by the processor cause the processor to select the designated commercial vehicle operator based, at least in part, on the rating specifying the desirability of the designated commercial vehicle operator.

20. The non-transient computer readable storage media of claim 11 wherein the vehicle data includes a distance value specifying a current distance of a commercial vehicle from a location of the shipment, and further comprising instructions which, when executed by the processor cause the processor to select the designated commercial vehicle operator based, at least in part, on the distance value specifying the current distance of the commercial vehicle corresponding from the location of the shipment, wherein the commercial vehicle corresponds to the designated commercial vehicle operator.
